(19) United States
(12) Patent Application Publication
(10) Pub. No.: US 2008/0203331 A1
(43) Pub. Date: Aug. 28, 2008

(54) MOBILE RADIATION TREATMENT FACILITY

(76) Inventor: Brent D. Murphy, South Bend, IN (US)

Correspondence Address: BARNES & THORNBURG LLP, 11 SOUTH MERIDIAN, INDIANAPOLIS, IN, 46204, US

(21) Appl. No.: 12/028,481

(22) Filed: Feb. 8, 2008

Related U.S. Application Data
(60) Provisional application No. 60/889,435, filed on Feb. 12, 2007.

(51) Int. Cl. G21F 3/04

(52) U.S. Cl. 250/517.1

(57) ABSTRACT

A mobile radiation treatment facility includes a patient treatment trailer having a treatment area configured to contain a radiation-emitting device. The patient treatment trailer includes a plurality of wheels such that it is configured to be towed by a vehicle to a desired location. The facility further includes radiation barriers including a plurality of liquid radiation barriers and a plurality of solid radiation barriers positioned adjacent the treatment area to block radiation emission from the radiation-emitting device. An associated method is also disclosed.

### CLAIM OF PRIORITY

This Application claims priority to U.S. Provisional Patent Application Ser. No. 60/889,435 filed on Feb. 12, 2007, the entirety of which is incorporated by reference herein.

### BACKGROUND

The present disclosure relates to a shielding system and particularly to radiation-shielding systems. More particularly, the present disclosure is related to a mobile radiation-shielding system for a mobile radiation treatment facility.

### SUMMARY

According to an aspect of the present disclosure, a mobile radiation treatment facility may include a patient treatment trailer having a treatment area configured to contain a radiation-emitting device. The patient treatment trailer may include a plurality of wheels such that it is configured to be towed by a vehicle to a desired location. The facility may further include radiation barriers including a plurality of liquid radiation barriers and a plurality of solid radiation barriers positioned adjacent the treatment area to block radiation emission from the radiation-emitting device.

According to another aspect of the present disclosure, a method of constructing a mobile radiation treatment facility may include transporting a patient treatment trailer and a patient-waiting trailer to a desired location. The method may further include positioning (i) first and second solid radiation barriers adjacent the patient treatment module and (ii) an overhead solid radiation barrier supported by the first and second solid radiation barriers above the patient treatment trailer. The method may further include positioning a first plurality of liquid radiation barriers adjacent the treatment trailer. The method may further include positioning a second plurality of liquid radiation barriers adjacent the first plurality of liquid radiation barriers such that the first plurality of liquid radiation barriers is between the patient treatment trailer and the second plurality of liquid radiation barriers.

According to another aspect of the disclosure, a mobile radiation treatment facility may include a wheeled patient treatment trailer having a treatment area configured to containing a radiation-emitting device. The facility may further include a wheeled patient-waiting trailer connected to the wheeled patient treatment trailer and having a common doorway with the wheeled patient treatment trailer. The method may further include a first plurality of radiation barriers adjacent the treatment area of the wheeled patient treatment trailer. The method may further include a second plurality of radiation barriers positioned adjacent the first plurality of radiation barriers such that the first plurality of radiation barriers is positioned between the second plurality of radiation barriers and the treatment area of the wheeled patient treatment trailer.

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a plan view of an illustrative embodiment of a mobile radiation-shielding system;

FIG. 2 is a perspective view of a satellite treatment site, such as a parking lot, showing general dimensions required for site preparation;

FIG. 3 is a view similar to FIG. 2, showing the satellite treatment site including a concrete base pad to support a mobile radiation-shielding system;

FIGS. 4-7 illustrate a sequence of assembling the mobile radiation-shielding system of FIG. 1 at the satellite treatment site;

FIG. 4 is a perspective view of the satellite treatment site showing a mobile treatment trailer coupled to a patient waiting trailer;

FIG. 5 is a view similar to FIG. 4 showing water tank trailers positioned adjacent to a treatment trailer;

FIG. 6 is a view similar to FIGS. 4 and 5, showing the mobile radiation-shielding system after positioning the concrete barrier shields adjacent the treatment trailer;

FIG. 7 is a view similar to FIGS. 5 and 6 showing the mobile radiation-shielding system after final preparation of the satellite treatment site including security fencing and landscaping,

FIG. 8 is a plan view of another illustrative mobile radiation-shielding system;

FIG. 9 is an end view of selected portions of the mobile radiation-shielding system of FIG. 8;

FIG. 10 is an end view of selected portions of the mobile radiation-shielding system of FIG. 8; and

FIG. 11 is another side view of selected portions of the mobile radiation-shielding system of FIG. 8.

### DETAILED DESCRIPTION

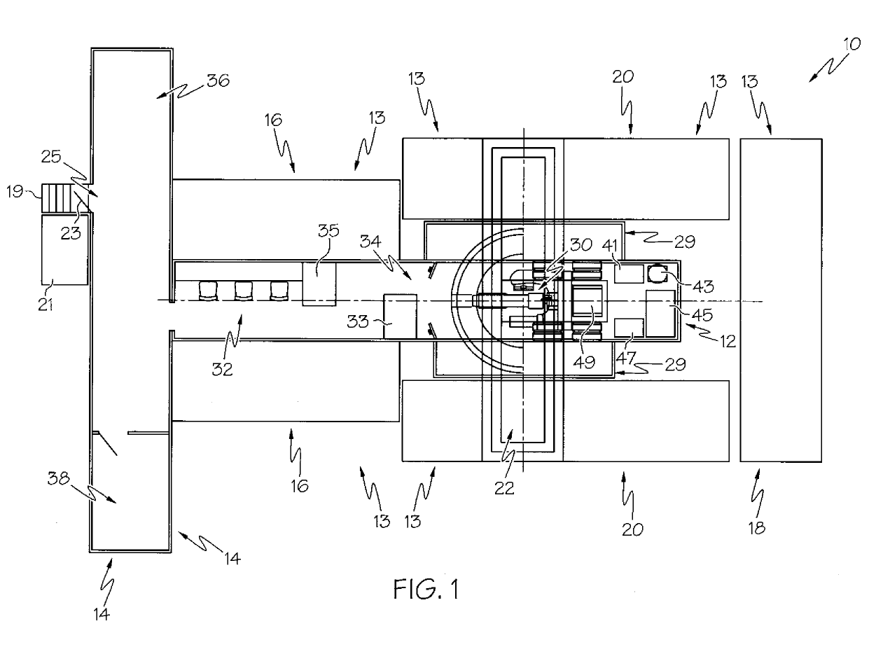

A mobile radiation-shielding system or facility 10 for a patient radiation therapy treatment includes a treatment trailer 12, a patient-waiting trailer 14, and radiation barriers 13 including water tank trailers 16, 18, ground-mounted concrete barrier shields 20, and an overhead concrete barrier shield 22 as shown in FIG. 1. In the illustrative system 10 shown in FIG. 1, the water tank trailer 18 has a greater tank capacity than the water tank trailers 16. The mobile treatment trailer 12 includes a radiation-emitting device 30 or any suitable device to provide intensity-modulated radiation therapy (IMRT). Illustratively, the radiation-emitting device 30 is a linear accelerator and positioned within a treatment area 34 of the trailer 12. The mobile treatment trailer 12 further includes an operator console area 32 to operate the device 30. In illustrative embodiments, the mobile treatment trailer 12 is a box trailer having a plurality of wheels and adapted to be moved by a semi-tractor or other suitable vehicle.

Governmental regulations prescribe the containment of radiation with the use of a radiation-emitting device 30. The mobile radiation-shielding system 10, and all other systems a facilities described herein, is configured to comply with these regulations when the device 30 is employed in a mobile venue outside of a fixed-base operation such as, for example, a hospital or nuclear medicine clinic. Thus, the mobile radiation-shielding system 10 is arranged to provide a mobile shielding capability that contains radiation produced during patient therapy.

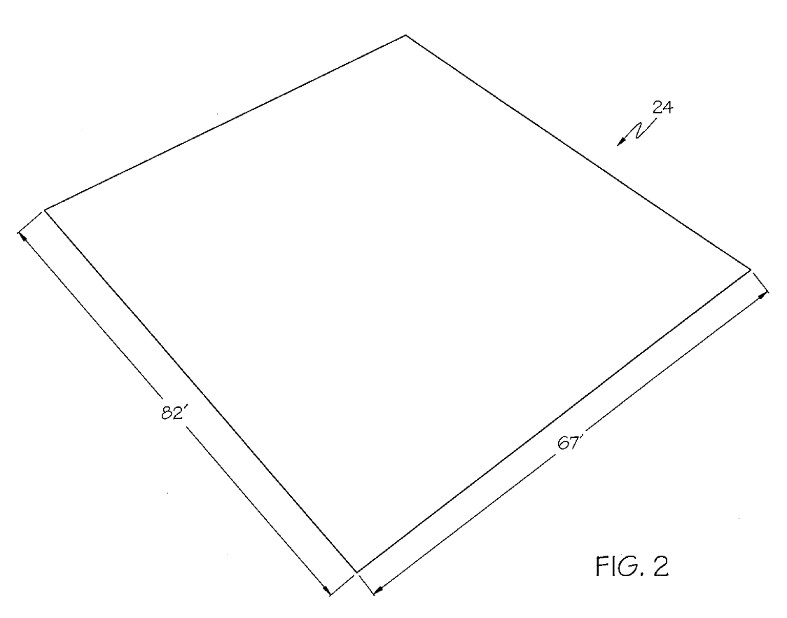

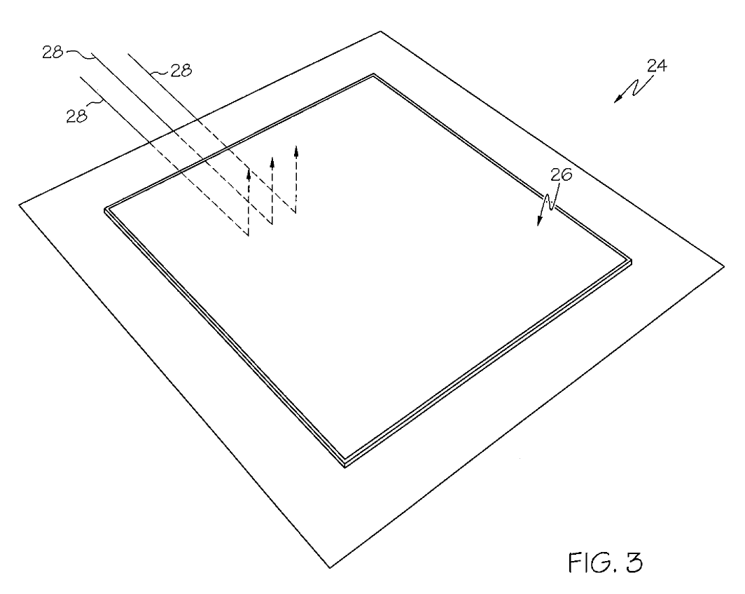

The treatment site 24 may be a remote location away from a medical center, or located in, for example, a parking lot adjacent to a medical center, or wherever additional radiation treatment facilities are desired. The treatment site may illustratively be an open area of about 82 feet by 67 feet as suggested in FIG. 2 or any other suitable size. Referring now to FIG. 3, the treatment site 24 may further include a concrete or other suitable weight-bearing surface 26 and utilities 28 such as water, sewage, and electricity.

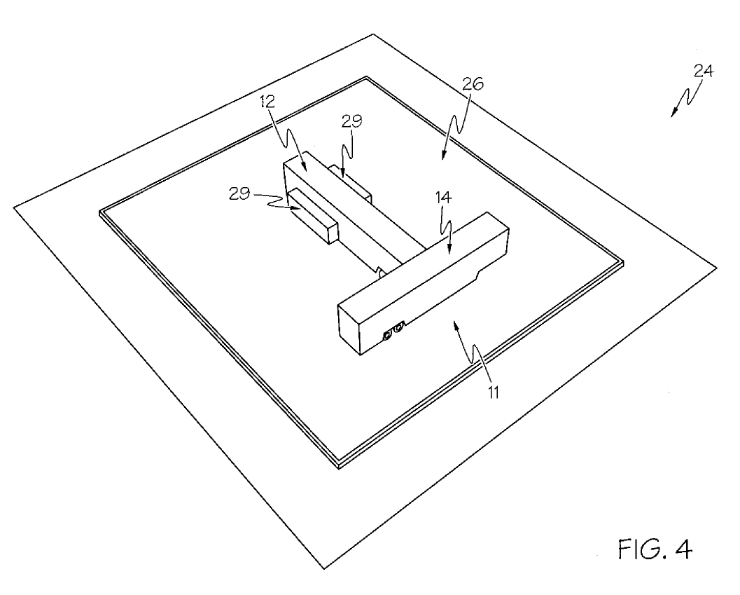

Upon the desired preparation of the treatment site 24, the treatment trailer 12 and the patient-waiting trailer 14 are positioned in a perpendicular relationship to one another and coupled to each other to permit access between the trailers 12, 14 as shown in FIG. 4. In illustrative embodiments, the trailers 12, 14 may be coupled to one another through a soft-pad connection. The semi-tractor (not shown) is used to position the trailers 12, 14 at the desired satellite treatment site 24.

The treatment trailer 12 includes internal water tanks 33, 35, which are positioned inside of the treatment trailer 12 to provide further shield capacity of about 2-3 tenth value layers (TVL) for the operator console area 32 and surrounding areas. The tanks 33, 35 are each positioned on an opposite side of the treatment trailer 12 in a maze-like configuration. The maze-like configuration provides appropriate shielding and a path of travel between the operator console 32 and the treatment area 34. In some embodiments, the water tanks 33, 35 may span from the floor to the ceiling of the trailer 12. A lead (Pb) pocket door (not shown) having about 2-inches thickness partitions the treatment area 34 from the operator console area 32 and provides about 2-3 TVL of shielding capacity. Of course, such a pocket door may have any suitable thickness to effectively provide additional shielding from the linear accelerator.

The treatment area 34 is also shown to illustratively include various equipment such as transformer 41, air supply 43, water chiller 45, and voltage converter 47. The treatment area 34 also includes linac modulator cabinet 49. The trailer 12 includes lateral extensions 29 providing more space in the treatment area 34.

A stairway 19 and ramp 21 allow access to the patient-waiting trailer 14 through door 23 and associated doorway 25. The patient-waiting trailer 14 includes a waiting room 36 and a physician consulting room 38, as shown best in FIG. 1. The illustrative patient-waiting trailer 14 does not include additional radiological shielding due to the distance between the device 30 and trailer 14. However, additional radiological shielding including, for example, lead barriers, water tanks, concrete barriers, etc., may be provided. In illustrative embodiments, the patient-waiting trailer 14 is a box trailer having a plurality of wheels and adapted to be moved by the semi-tractor or other suitable vehicle.

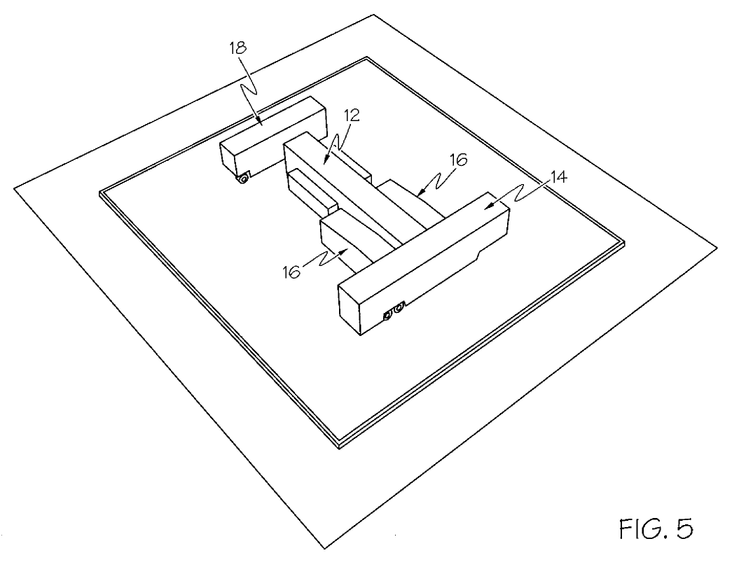

In illustrative embodiments, the water tank trailers 16 are fractionated in design and constructed of steel. The water tank trailers 16 are about 8.5 feet wide and 24 feet long and include a wheeled chassis. The trailers 16 are positioned in a spaced-apart relation to one another adjacent to the area of the operator console 32 along treatment trailer 12 as shown in FIGS. 1 and 5. In constructing the system 10, the water tank trailers 16 are deployed to the satellite treatment site empty and filled with water after being positioned adjacent to the treatment trailer 12. Illustratively, each water tank trailer 16 provides about 2-3 TVL of shielding capacity.

The water tank trailer 18 is of similar construction as the water tank trailers 16, but is about 34 feet in length. The water tank trailer 18 is positioned in a perpendicular relation to the treatment trailer 12 on the end opposite of the patient-waiting trailer 14 as shown in FIGS. 1 and 5. The water tank trailer 18 provides about 2-3 TVL of shielding capacity.

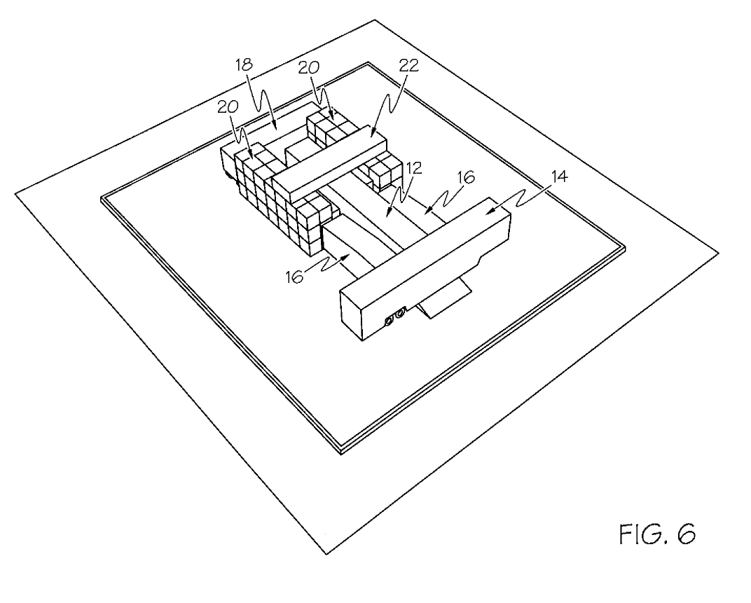

The concrete barrier shields 20 are erected adjacent the treatment trailer 12 to establish a structure of about 8.5 feet wide, 34 feet in length, and a height slightly higher than the treatment trailer 12 as shown in FIGS. 1, 6, and 7. Thus, the concrete barrier shields 20 create a predetermined “standoff” area between the barrier shields 20 and the linear accelerator. In other words, the barrier shields 20 and the standoff distance away from linear accelerator 30 cooperate to provide about 6 TVL of shielding capacity. The concrete barrier shields 20 are erected to block primary beam, scatter, and leakage radiation emanating from the linear accelerator 30. The overhead concrete barrier shield 22 is positioned to extend between and cooperate with the barrier shields 20 to confront both lateral radiation scatter and sky shine radiation escaping from the linear accelerator 30. Illustratively, the concrete barrier shields 20, 22 are constructed using a concrete density of about 2.36 g/cm³.

The water tanks 33, 35, the water tank trailers 16, 18, concrete barrier shields 20, and the overhead concrete barrier shield 22 cooperate to provide secondary barriers to shield the linear accelerator 30. Secondary barriers are arranged to shield “scatter” radiation and “leakage” radiation. Scatter radiation is defined as the radiation reflecting off of the patient, walls of the treatment room, or off of any barrier. Leakage radiation is defined as that radiation leaking from a head of the linear accelerator 30 which constitutes about 1% of a primary beam of radiation generated by the linear accelerator 30. In some embodiments, additional water tank trailers may be used, for example, when a linear accelerator not having a beam stop is used, or whenever additional shielding is desirable.

Considerations for shielding are predicated on a workload for the treatment facility of about 30 patients at about 200 cGy per patient at isocenter, five days per week, or about 30,000 cGy per week, equaling about 30,000 R per week. Use factors for primary barriers are based on clinical estimates of beam direction. The use factor for secondary barriers is about 1.0. The occupancy factors considered are based on those listed in the National Council on Radiation Protection and Measurements (NCRP) Report Number 151. The occupancy factors for work areas are about 1.0. A permissible level of radiation for unrestricted areas (operator console area 32 or within 30 feet of the linear accelerator) is a maximum of about 100 mRem per year. A permissible level of radiation for restricted areas (at least 30 feet away from the linear accelerator) is based upon an ALARA I (as low as reasonably achievable) level of about 500 mRem per year. While the illustrative mobile radiation-shielding system 10 is configured to accommodate at least these considerations, it is within the scope of this disclosure for the system 10 to also accommodate increased or decreased workload specifications.

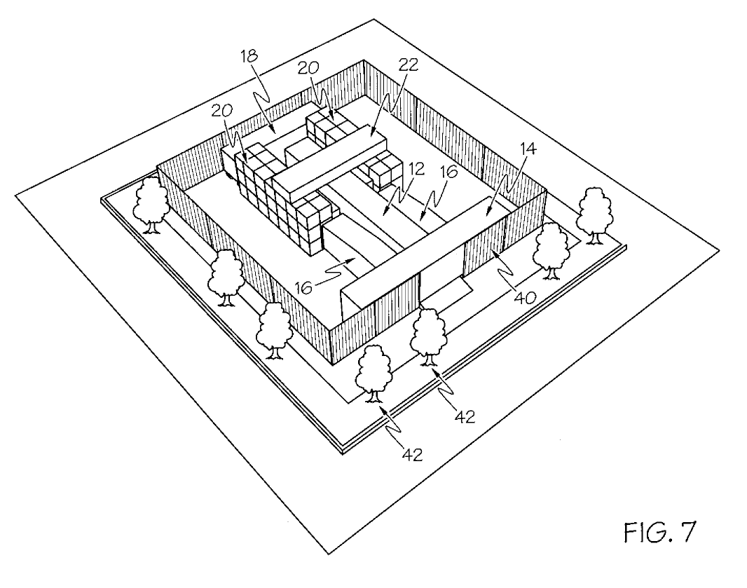

As noted above, the illustrative mobile radiation-shielding system 10 is arranged to be movable. In other words, the system 10 includes a variety of different trailers (i.e., the mobile treatment trailer 12, the patient-waiting trailer 14, the water tank trailers 16, 18, and the barrier shields 20, 22) which may be arranged in a variety of configurations, including that shown in FIGS. 1, 6, and 7, to provide a suitable radiation shielding system. Furthermore, additional trailers and/or barriers may be provided as well. If an operator of the system desires greater permanence, a security/privacy fence 40 and landscaping 42 may be installed as desired, as shown in FIG. 7. Although shown to be erected in a particular sequence, the system 10 may be constructed in another sequence as well. Further, the facility 10 and all other facilities described herein may be torn down, moved to another site and re-erected, as desired.

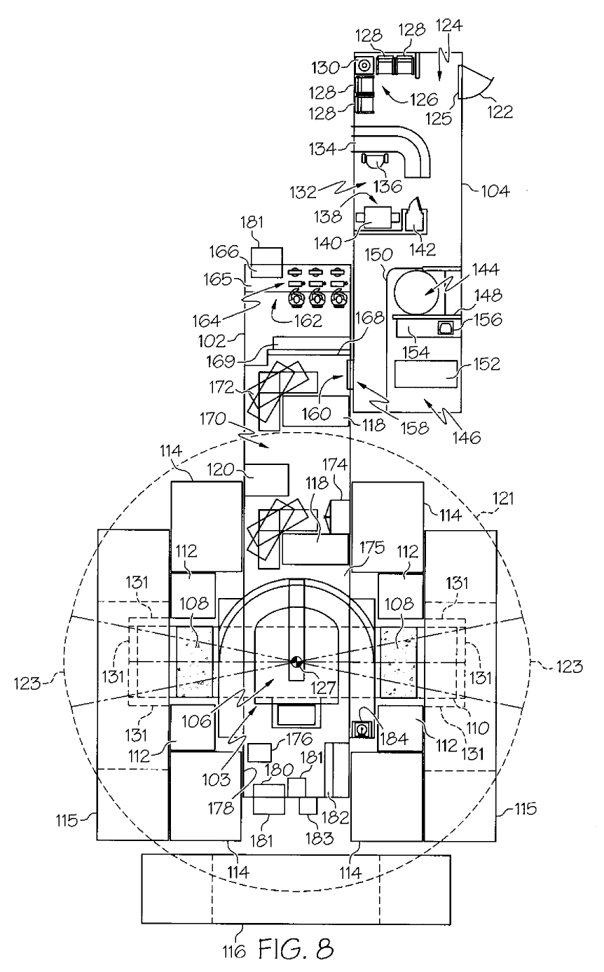

FIG. 8 shows a plan view of another mobile radiation-shielding system or facility 100, which may be assembled at a treatment site, such as the treatment site 24. The mobile radiation-shielding system 100 includes a treatment trailer 102 and a patient-waiting trailer 104. Similar to the treatment trailer 12, the treatment trailer 102 includes a radiation-emitting device 106 located in a treatment area 103. In the illustrative embodiment shown in FIG. 8, the radiation-emitting device 106 is a Tomotherapy Hi-ART Linac. However, any suitable device may be used to provide IMRT. Similar to the trailers 12, 14, in illustrative embodiments, both the treatment trailer 102 and patient-waiting trailer 104 are each a box trailer adapted to be transported by a semi-tractor or other suitable vehicle.

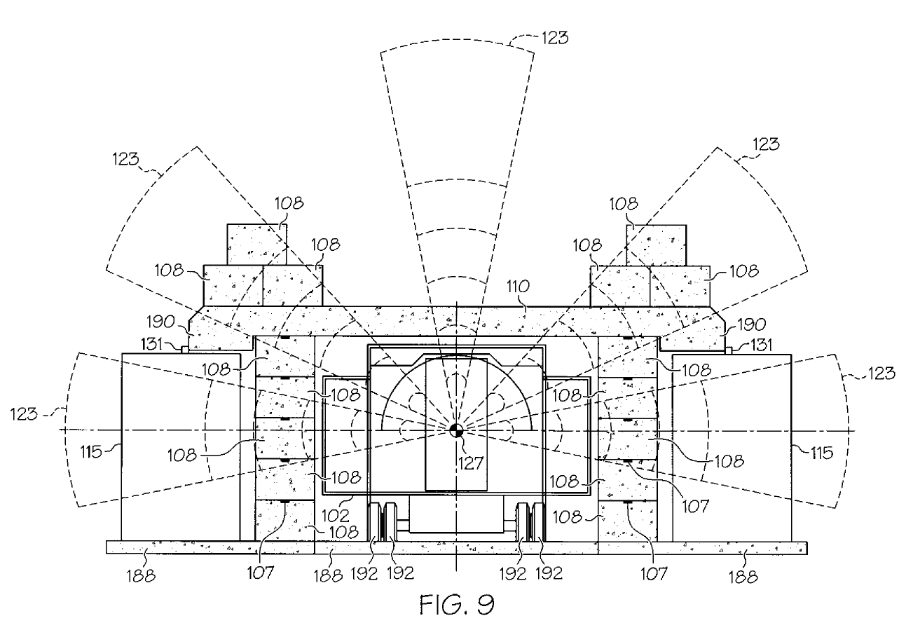

FIG. 8 also shows an illustrative arrangement of radiation barrier shield modules configured to provide shielding for the environment surrounding the radiation-emitting device 106. Ground-mounted, concrete barrier shields 108 are placed along the sides of the treatment trailer 102. An overhead concrete barrier shield 110, shown in phantom, is supported above the treatment trailer 102 by the concrete barrier shields 108 and is shown in further detail in FIGS. 9-11.

Barrier shield tanks are also implemented in the configuration illustratively shown in FIG. 8, which may be used to hold fluid substances for radiation shielding. In the illustrative embodiment shown in FIG. 8, the barrier shield tanks are filled with water. It should be appreciated that solid flowable substances may be used to fill the barrier shield tanks as well, such as sand, for example. In the configuration shown in FIG. 8, three differently-sized tank styles are illustratively used as barrier shields external to the treatment trailer 102. A barrier shield tank 112 is placed at each end of the concrete barrier shields 110. In this illustrative embodiment shown in FIG. 8, tanks 112 are 5 feet wide, 5 feet long, and 12 feet high. A tank 114 is placed adjacent one of the tanks 112. Each tank 114 is positioned such that each tank 114 is adjacent the treatment trailer 102 and one of the tanks 112 as illustrated in FIG. 8. In the illustrative embodiment of FIG. 8, each tank 114 is 8 feet wide, 10 feet deep, and 12 feet high.

The largest-sized tanks 115, 116 are positioned as the outer boundary barrier shields of the configuration illustratively shown in FIG. 8. A lateral tank 115 is positioned along each side of the treatment trailer 102 such that the longitudinal axes of the lateral tanks 115 are substantially parallel to the longitudinal axis of the patient trailer 102. An end tank 116 is also positioned at an end of the patient trailer 102 such that the longitudinal axis of the end tank 116 is substantially perpendicular to the longitudinal axis of the treatment trailer 102. In the illustrative embodiment of FIG. 8, the tanks 115, 116 are each 35 feet long at the longest point, 8 feet wide, and 12 feet, 6 inches high.

The treatment trailer 102 internally includes barrier shield tanks 118, 120, which may be filled with various fluids, or flowable solids, to provide proper radiation shielding. In the illustrative embodiment shown FIG. 8, the tanks 118, 120 are filled with water with the tanks 118 each having a 1,935 gallon capacity and the tank 120 having a 1,247 gallon capacity. The tanks 118, 120 are staggered such that a maze-like path is created allowing the tanks to serve as radiation barrier shields, while providing a path of travel along the treatment trailer 102.

An isocenter 127 is shown in FIG. 8 representing the origination point of the radiation emitted from the device 106. FIG. 8 also illustrates zones in which primary and secondary radiation shielding may be present in order to comply with governmental radiation-shielding requirements. The various barrier shield modules implemented in FIG. 8 act as barrier shields for both primary and secondary beams from the device 106. The primary beams originate from radiation coming directly from the device 106, while secondary beams may result from leakage and scattering as previously discussed.

Sections 123 represent sections along which primary beam radiation is emitted and in which primary barriers are used. In FIG. 8, the concrete barriers 108, 110 and lateral tanks 115 are used as the primary barriers. A secondary shielding zone 121 is a hemispherical zone in which secondary barriers can be implemented to shield from secondary beams emitted from the device 106. The tanks 112, 114, 115, 116, 118, and 120 provide a secondary barrier shield in the zone 121. The sections 123 each illustratively encompass 23 degrees of the zone 121 in FIG. 8. However, the size of the sections 123 may vary based upon the operating characteristics of the device 106.

The shielding configuration shown in FIGS. 8-11 is based upon a workload of 8575 Gy/week. The 8575 Gy/week is based upon operating for 8 hours a day, 5 days a week with 15-20 minute time slots averaging 3.5 patients per hour. The average radiation transmission time is 7 minutes at a dose rate of 8.75 Gy/min. It should be appreciated that the barrier shield configuration shown in FIGS. 8-11 may be arranged differently based upon the anticipated workload and strength of the radiation produced by the device 106. The water and concrete illustratively used in FIG. 8 can have densities of 1 g/cm³ and 2.32 g/cm³, respectively. Other materials of various densities can also be used for shielding such as: sand (1.6 g/cm³), lead (11.35 g/cm³), and steel (7.87 g/cm³).

Referring now to the patient-waiting trailer 104, FIG. 8 shows the trailer 104 to include an entrance door 122 and doorway 125. The patient waiting trailer 104 includes a wheelchair storage area 124 and a patient waiting room 126.

FIG. 8 illustratively shows the waiting room 126 as including a plurality of chairs 128 and a table 130. The trailer 104 also illustratively includes a reception area 132 having a desk 134 and chair 136. The trailer 104 also includes an office equipment area 138 shown illustratively as including a copy machine 140. A storage area 142 is located adjacent the office equipment area 138.

The patient-waiting trailer 104 also includes a changing room 144 and an examination room 146 separated by a wall 148. A curtain track 150 can be configured to support and guide privacy curtains used to provide privacy for both the changing room 144 and examination room 146. As illustratively shown, the examination room 146 includes an examination table 152 and counter top 154 having a sink 156 built therein. In the illustrative embodiment of FIG. 8, the patient-waiting trailer 104 is 12 feet, 5 inches wide and 40 feet, inches long.

As illustratively shown in FIG. 8, the patient-waiting trailer 104 includes a doorway 158 that may be aligned with a doorway 160 of the treatment trailer 102. The doorways 158, 160 can be coupled to one another by a soft pad connection so that the physical doorway provides a substantially even surface allowing travel to be relatively unobstructed by any bumps or steps resulting from crossing over from one trailer to the next. Each doorway 158, 160 can also include a door.

Referring now to the treatment trailer 102, FIG. 8 illustratively shows an operator console area 162 having a plurality of operator consoles 164. The operator station 162 is used to control the radiation-emitting device 106. The operator station 162 may also include a countertop 165 and storage cabinet 166. A wall 168 separates the operator station 162 from the treatment area 103. In one embodiment, the wall 168 can be illustratively formed of steel studs and lead-lined gypsum board. The wall 168 may also be of a height lower than the floor-to-ceiling distance in the operator station 162 of the treatment trailer 102. The wall 168 may also include a table 169 extending therefrom.

Adjacent the doorway 160 is a hallway 170. As previously described, the tanks 118, 120 are arranged in a maze-like arrangement to provide radiation shielding to the operator station 162 and surrounding areas, while still allowing a path of travel along the hallway 170. A stretcher 172 is shown in various positions to illustrate how the stretcher 172 can be guided around the tanks 118, 120 to travel to the treatment area 103 and back to the doorway 160. A cabinet 174 is located in the hallway 170 and secured to an interior wall of the treatment trailer 102.

In addition to the radiation-emitting device 106, the illustrative treatment area 103 further includes a blood tray storage area 175, electronics cabinet 176, electrical panel 178, general storage drawers 180, plenum 182, workbench 184, and mobile sink 186. Of course, it is within the scope of this disclosure to include other equipment and storage areas.

External to the treatment trailer 102 is environmental control equipment such as air conditioning units 181 and a chiller 183. It should be appreciated that conduits, piping, etc., responsible for conducting air and fluids through the treatment trailer 102 and patient-waiting trailer 104 are appropriately shielded for radiation exposure. In the embodiment shown in FIG. 8, the treatment trailer 102 is 12 feet, 5 inches wide and 60 feet, 5 inches long.

Referring now to FIG. 9, an end view of the treatment trailer 102 is shown with the end tank 116, and tanks 112, 114 removed for purposes of illustration. As shown in FIG. 9, a plurality of concrete pads 188 are placed on the ground allowing the lateral tanks 115 and concrete barrier shields 108 to be placed thereon. As shown, the ground-mounted concrete barrier shields 108 may be stacked on one another. Each concrete barrier shield 108 may include a lift ring 107 used to lift the shields 108 for stacking or disassembly. The concrete barrier shields 108 are stacked on each side of the trailer to a height greater than that of the treatment trailer 102.

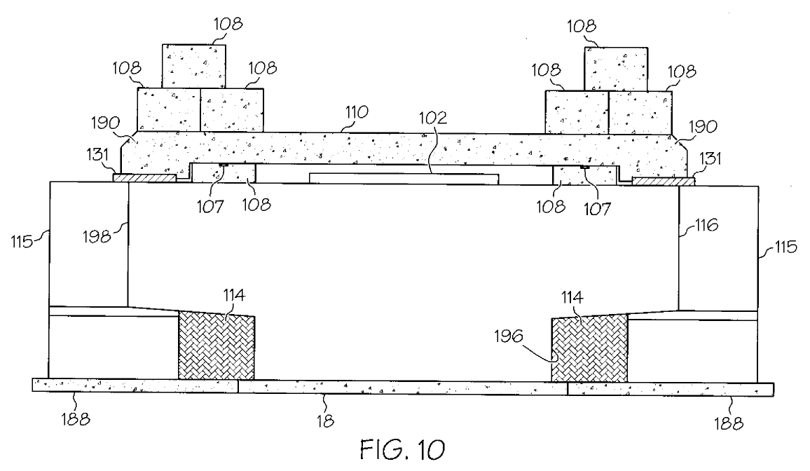

The overhead concrete barrier shield 110 is supported by the stacks of barrier shields 108. The overhead concrete barrier shield 110 includes overhanging portions 190, which are each suspended above a lateral tank 115. Lead closure blocks 131 are placed on each lateral tank 115 to provide radiation shielding for radiation that may radiate through the gap between the overhang portions 190 and the lateral tanks 115. In FIG. 9, lead closure blocks 131 positioned perpendicular to the treatment trailer 102 are not shown for purposes of illustration, but are shown emplaced in FIG. 10. A plurality of concrete barrier shields 108 are also placed on each end of the overhead concrete barrier shield 110 to further stabilize the overhead concrete barrier shield 110.

The treatment trailer 102 includes wheels 192. An electrical generator compartment 194 is located on the underside of the treatment trailer 102, which houses an electrical generator. The primary beam emission paths 123 are shown along which primary barriers can be implemented similar to that described in regard to FIG. 8.

FIG. 10 shows an end view of the treatment trailer 102 showing the illustrative arrangement of barrier shield tanks. The end tank 116 is shown as being positioned on a concrete slab 188. The end tank 116 illustratively includes a lower tank portion 196 and an upper tank portion 198. The lower tank portion 196 is shown in FIG. 9 as being narrower than the upper tank portion 198. The lateral tanks 115 are similarly shaped in the illustrative embodiment of FIG. 9. It should be appreciated that the shape of tanks 115, 116 shown in FIG. 9 is illustrative and other tank shapes may be utilized for proper radiation shielding.

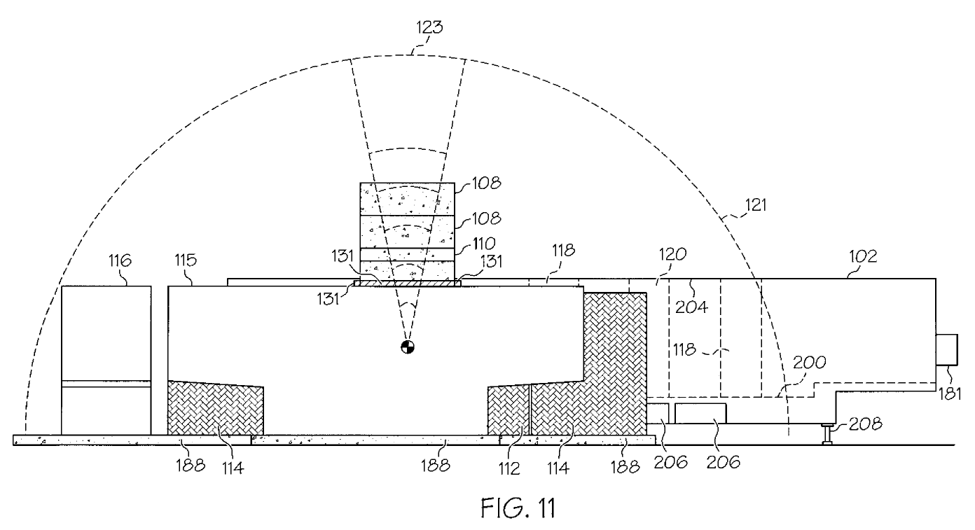

Referring now to FIG. 11, a side view of the treatment trailer 102 with the patient-waiting trailer 104 removed is shown. FIG. 11 illustrates the position of the tanks 118, 120 inside the treatment trailer 102. As illustrated in FIG. 10, the tanks 118, 120 span the height of from a floor 200 of the treatment trailer 102 to the interior 202 of the upper surface 204 of the treatment trailer 102. The treatment trailer 102 is also shown as including a plurality of storage compartments 206 located in the bottom of the treatment trailer 102 and are accessible from the outside of the trailer 102. A support 208 is shown as supporting an end of the trailer 102. FIG. 11 also illustrates primary and secondary beam zones. The section 123 indicates the secondary beam zone and zone 121 indicates the primary beam zone.

Similar to the embodiment shown in FIGS. 1-7, the system 100 is mobile and can be assembled at a treatment site 24. For example, the treatment trailer 102 and patient waiting trailer 104 may be moved into position such as that shown in FIG. 8 via semi-tractor. Each trailer 102, 104 can be connected to the appropriate utilities 28, such as water, sewage, electricity, etc., at the treatment site 24. Concrete barrier shields 108 may be stacked upon one another adjacent the treatment trailer 102 and the overhead concrete barrier shield 110 may be emplaced after the concrete barrier shields 108 are stacked to a proper height. Once the overhead barrier shield 110 is emplaced, additional concrete barrier shields may be placed on top of the overhead barrier 110, as illustrated in FIG. 9.

The tanks 112, 114, 115, 116 may be emplaced subsequent to the concrete barrier shields 108, 110 being emplaced. Each of the tanks 112, 114, 115, 116 may be transported empty to the treatment site 24 and filled when placed into position. Once the tanks 115 are emplaced, the lead blocks 131 can be emplaced to cover the gap between the concrete overhead barrier shield 110 and the tanks 115, as illustrated in FIG. 9. The tanks 118, 120 inside the treatment trailer 102 can also be filled prior to use of the device 106.

There are a plurality of advantages of the present disclosure arising from the various features of the apparatus, systems, and methods described herein. It will be noted that alternative embodiments of the apparatus, systems, and methods of the present disclosure may not include all of the features described yet still benefit from at least some of the advantages of such features. Those of ordinary skill in the art may readily devise their own implementations of apparatus, systems, and methods that incorporate one or more of the features of the present disclosure and fall within the spirit and scope of the present disclosure.

1. A mobile radiation treatment facility comprising:
a patient treatment trailer including a treatment area configured to contain a radiation-emitting device, the patient treatment trailer having a plurality of wheels such that the patient treatment trailer is configured to be towed by a vehicle to a desired location, and
radiation barriers including a plurality of liquid radiation barriers and a plurality of solid radiation barriers positioned adjacent the treatment area to block radiation emission from the radiation-emitting device.

2. The mobile radiation treatment facility of claim 2, wherein the patient treatment trailer includes an operator console area including controls configured to operate the radiation-emitting device.

3. The mobile radiation treatment facility of claim 2 further comprising a patient-waiting trailer coupled to the patient treatment trailer.

4. The mobile radiation treatment facility of claim 3, wherein the patient-waiting trailer includes a plurality of wheels such that the patient-waiting trailer is configured to be towed by a vehicle to the desired location.

5. The mobile radiation treatment facility of claim 4, wherein the patient treatment trailer includes a first doorway and the patient-waiting trailer includes a second doorway aligned with the first doorway to create a passage between the patient-waiting trailer and the patient treatment trailer.

6. The mobile radiation treatment facility of claim 5, wherein the longitudinal axis of the patient-waiting trailer is positioned substantially perpendicular to the longitudinal axis of the patient treatment trailer.

7. The mobile radiation treatment facility of claim 5, wherein the longitudinal axis of the patient-waiting trailer is positioned substantially parallel to the longitudinal axis of the patient treatment trailer.

8. The mobile radiation treatment facility of claim 1, wherein:
the patient treatment trailer includes a treatment area configured to contain the radiation-emitting device, and
the plurality of solid radiation barriers includes first and second concrete barriers positioned adjacent the treatment area of the treatment trailer, and an overhead concrete barrier extending between the first and second concrete barriers and positioned above the treatment area.

9. The mobile radiation treatment facility of claim 8, wherein the plurality of liquid radiation barriers includes;
a first pair of water tanks each positioned adjacent the first concrete barrier and the patient treatment trailer, and
a second pair of water tanks each positioned adjacent the second concrete barrier and the patient treatment trailer.

10. The mobile radiation treatment facility of claim 9, wherein the plurality of liquid radiation barriers further includes:
a third pair of water tanks each positioned adjacent one of the first pair of water tanks and the patient treatment trailer, and
a fourth pair of water tanks each positioned adjacent one of the second pair of water tanks and the patient treatment trailer.

11. The mobile radiation treatment facility of claim 10, wherein the plurality of liquid radiation barriers further includes:
a first lateral water tank positioned such that the first concrete barrier is positioned between the first lateral water tank and the patient treatment trailer and such that the longitudinal axis of the first lateral water tank is parallel to the longitudinal axis of the patient treatment trailer,
a second lateral water tank positioned such that the second concrete barrier is positioned between the second lateral water tank and the patient treatment trailer and that the longitudinal axis of the second lateral water tank is parallel to the longitudinal axis of the patient treatment trailer, and
an end water tank positioned adjacent an end of the patient treatment trailer and such that the longitudinal axis of the end water tank is perpendicular to the longitudinal axis of the patient treatment trailer.

12. The mobile radiation treatment facility of claim 1 further comprising a plurality of internal water tanks positioned between the operator console area of the patient treatment trailer and the treatment area of the patient treatment trailer, such that the plurality of internal water tanks are arranged to provide a maze-like path within the patient treatment trailer.

13. The mobile radiation treatment facility of claim 1, wherein at least one of the plurality of liquid radiation barriers is positioned on a wheeled chassis configured to be towed by a vehicle to a desired location.

14. A method of constructing a mobile radiation treatment facility, the steps comprising:
transporting a patient treatment trailer and a patient-waiting trailer to a desired location,
positioning (i) first and second solid radiation barriers adjacent the patient treatment trailer and (ii) an overhead solid radiation barrier supported by the first and second solid radiation barriers above the patient treatment trailer,
positioning a first plurality of liquid radiation barriers adjacent the treatment trailer, and
positioning a second plurality of liquid radiation barriers adjacent the first plurality of liquid radiation barriers such that the first plurality of liquid radiation barriers is between the patient treatment trailer and the second plurality of liquid radiation barriers.

15. The method of claim 14, further comprising connecting the patient treatment trailer to the patient-waiting trailer such that the longitudinal axis of the patient treatment trailer is parallel to the longitudinal axis of the patient-waiting trailer.

16. The method of claim 14, further comprising connecting the patient treatment trailer to the patient-waiting trailer such that the longitudinal axis of the patient treatment trailer is perpendicular to the longitudinal axis of the patient-waiting trailer.

17. The method of claim 14, wherein:
positioning the first and second solid radiation barriers comprises positioning first and second concrete barriers adjacent the patient treatment module, and
positioning the overhead solid radiation barrier comprises positioning an overhead concrete barrier supported by the first and second concrete barriers above the patient treatment trailer.

18. The method of claim 14, wherein:
positioning the first plurality of liquid radiation barriers comprises positioning a first plurality of water tanks adjacent the patient treatment trailer, and
positioning the second plurality of liquid radiation barriers comprises positioning a second plurality of water tanks adjacent the first plurality of water tanks such that the first plurality of water tanks are between the patient treatment trailer and the second plurality of water tanks.

19. A mobile radiation treatment facility comprising:
a wheeled patient treatment trailer having a treatment area configured to containing a radiation-emitting device,
a wheeled patient-waiting trailer connected to the wheeled patient treatment trailer and having a common doorway with the wheeled patient treatment trailer,
a first plurality of radiation barriers adjacent the treatment area of the wheeled patient treatment trailer, and
a second plurality of radiation barriers positioned adjacent the first plurality of radiation barriers such that the first plurality of radiation barriers is positioned between the second plurality of radiation barriers and the treatment area of the wheeled patient treatment trailer.

20. The mobile radiation treatment facility of claim 19, wherein the first plurality of radiation barriers includes at least one solid radiation barrier formed of concrete or lead.

21. The mobile radiation treatment facility of claim 20, wherein:
the first plurality of radiation barriers comprises a first plurality of tanks filled with water or sand,
the second plurality of radiation barriers comprises a second plurality of tanks filled with water or sand.

22. The mobile radiation treatment facility of claim 19, wherein the wheeled patient treatment trailer includes an operator console area including controls configured to operate the radiation-emitting device and a plurality of internal radiation barrier tanks positioned between the operator station and the treatment area to provide a maze-like path within the patient treatment trailer.
